(19) United States
(12) Patent Application Publication
(10) Pub. No.: US 2025/0305089 A1
(43) Pub. Date: Oct. 2, 2025

(54) OXIDATIVE AND REDUCTIVE LEACHING METHODS

(71) Applicant: BASF SE, Ludwigshafen am Rhein (DE)

(72) Inventors: Wolfgang ROHDE, Ludwigshafen (DE); Till GERLACH, Ludwigshafen (DE); Andrea MAGIN, Ludwigshafen (DE); Nils-Olof Joachim BORN, Ludwigshafen (DE); Kerstin SCHIERLE-ARNDT, Ludwigshafen (DE)

(21) Appl. No.: 18/881,503

(22) PCT Filed: Aug. 1, 2023
(86) PCT No.: PCT/EP23/71346

§ 371 Date: Jan. 6, 2025

(30) Foreign Application Priority Data
Aug. 9, 2022 (EP) 22189597.2

(51) Int. Cl. C22B 15/00; C22B 1/02; C22B 1/24; C22B 7/00; H01M 10/54

(52) U.S. Cl. CPC C22B 15/0071; C22B 1/02; C22B 1/24; C22B 7/007; C22B 15/0013; C22B 15/0028; H01M 10/54

(57) ABSTRACT

Disclosed herein are methods for obtaining a composition including copper sulfide from a material, where the methods include: contacting the material with an acidic aqueous solution having a pH less than 6 in the presence of sulfur dioxide to form copper sulfide; where the material includes one or more copper compounds chosen from copper in a zero oxidation state, copper oxide, and copper hydroxide, and where the material includes an amount of zero oxidation state metals having a standard redox-potential less than zero volt versus a standard hydrogen electrode. Also disclosed are methods for recycling at least one battery material, and compositions including copper sulfide.

The project leading to this application has received funding from Bundesministerium for Wirtschaft und Klimaschutz (DE; FKZ:16BZF101A); the applicant bears responsibility for all disclosures herein.

Disclosed herein are methods for obtaining a composition comprising copper sulfide from a material, wherein the methods comprise: contacting the material with an acidic aqueous solution having a pH less than 6 in the presence of sulfur dioxide to form copper sulfide; wherein the material comprises one or more copper compounds chosen from copper in a zero oxidation state, copper oxide, and copper hydroxide, and wherein the material comprises an amount of zero oxidation state metals having a standard redox-potential less than zero volt versus a standard hydrogen electrode. Also disclosed are methods for recycling at least one battery material, and compositions comprising copper sulfide.

Lithium ion battery materials and value metal ores are complex mixtures of various elements and compounds. For example, many lithium ion battery materials contain valuable metals such as lithium, aluminum, nickel, cobalt, copper, and/or manganese. It may be desirable to recover various elements and compounds from lithium ion battery materials and value metal ores. For example, it may be advantageous to recover lithium, aluminum, nickel, cobalt, copper, and/or manganese.

High purity lithium is a valuable resource. Many sources of lithium, such as lithium ion batteries, lithium ion battery waste, lithium containing water, e.g. ground water, and raw lithium containing ores, are complex mixtures of various elements and compounds. The removal and purification of lithium from a material, such as a lithium ion battery material, are exemplary steps in the recycling of lithium ion batteries. Lithium ion battery materials are complex mixtures of various elements and compounds, and it may be desirable to remove various non-lithium impurities. Such impurities may exist in a variety of oxidation states which may impact, for example, the efficiency of a leaching process. For example, in some leaching processes high oxidation state metals may be more or less efficiently leached than low or zero oxidation state metals. Some non-lithium impurities are also valuable resources, and it may additionally be desirable to separate and purify various elements and compounds from such materials.

Accordingly, there is a need for processes for removing lithium from materials such as, for example, a battery material and processes for recycling lithium ion battery materials. Further, for example, there is a need for processes for extracting value metals such as copper. For example, there is a need for leaching methods for efficiently and effectively leaching complex mixtures of various elements and compounds such as, for example, mixed metals coexisting in a variety of oxidation states. For example, there is a need for economic processes with high lithium recovery and high lithium purity. There is also a need for economic processes with high recovery and high purity for removing value metals such as, for example, nickel, copper, and cobalt, from materials.

CN 114 634 192 A discloses a waste lithium ion battery black mass recovery method and device. The method uses black mass obtained from lithium iron phosphate batteries. The waste lithium ion battery black mass recycling method comprises the following steps: adding a solvent to the black mass, stirring to prepare a slurry, then adding oxygen, sulfur dioxide and a first inorganic acid solution into the slurry for reaction, and filtering the slurry after reaction to obtain a first recycled material and a first solution; wherein the first recycled material comprises iron phosphate, and the first solution comprises Li⁺. By adding oxygen, sulfur dioxide and a small amount of inorganic acid to the slurry containing black mass, oxygen and sulfur dioxide oxidize Fe²⁺ in lithium iron phosphate to form Fe³⁺ under acidic conditions, and Fe³⁺ reacts with PO₄³⁻ in lithium iron phosphate to form precipitated iron phosphate. Soluble carbonate is added to the first solution to precipitate lithium carbonate, and lithium carbonate and a second solution are obtained by filtration.

Disclosed are methods for obtaining a composition comprising copper sulfide from a material, wherein the methods comprise: contacting the material with an acidic aqueous solution having a pH less than 6 in the presence of sulfur dioxide to form copper sulfide; wherein no oxidizing agent is added during the contacting step; wherein the material comprises one or more copper compounds chosen from copper in a zero oxidation state, copper oxide, and copper hydroxide, and wherein the material comprises an amount of zero oxidation state metals having a standard redox-potential less than zero volt versus a standard hydrogen electrode.

In some embodiments, the method further comprises separating the composition comprising copper sulfide from the aqueous solution by a solid-liquid separation.

In some embodiments, the method further comprises purifying the composition comprising copper sulfide by a solid-solid separation.

In some embodiments, the composition comprises from 0.1 weight percent to 100 weight percent, e.g., from 1 weight percent to 100 weight percent of copper sulfide; by total weight of the composition.

In some embodiments, the acidic aqueous solution comprises H₂SO₄.

In some embodiments, the material is a lithium ion battery material comprising one or more chosen from black mass, cathode active material, cathodes, cathode current collector foils, cathode active material precursors, graphite, anodes, anode current collector foils, and combinations thereof.

In some embodiments, the material comprises: from 0 weight percent to 10 weight percent lithium, from 0.1 weight percent to 60 weight percent nickel, from 0 weight percent to 20 weight percent cobalt, from 0.1 weight percent to 20 weight percent aluminum, from 0 weight percent to 20 weight percent iron, from 0 weight percent to 20 weight percent manganese, and from 0 weight percent to 20 weight percent zinc; wherein each weight percent is by total weight of the material; wherein an amount of at least one of the nickel, cobalt, aluminum, iron, manganese, and zinc is present as a zero oxidation state metal; and wherein the material has a molar ratio of copper to the amount of zero oxidation state metals having a standard redox-potential less than zero volt versus a standard hydrogen electrode ranging from 1:0.1 to 1:10.

In some embodiments, the material, or a precursor thereof, is pyrolyzed prior to the contacting step.

In some embodiments, contacting the material with an acidic aqueous solution having a pH less than 6 in the presence of sulfur dioxide causes a formation of hydrogen gas and hydrogen sulfide gas, and wherein after the formation of hydrogen gas and hydrogen sulfide gas, the method comprises adding an oxidizing agent chosen from O₂, N₂O, a mixture of air with 0.1 to 5 vol % sulfur dioxide, a mixture of oxygen with 0.1 to 5 vol % sulfur dioxide, and combinations thereof.

In some embodiments, the method further comprises adding air after the contacting step.

In some embodiments, the acidic aqueous solution has a concentration of acid ranging from 18 mol/L to 0.0001 mol/L.

In some embodiments, sulfur dioxide is fed during the contacting step as a gas at a rate of 1 to 500 NI/kg of the material.

In some embodiments, subsequent to the contacting step, the method further comprises adding an additional material comprising one or more chosen from metal oxides, metal hydroxides, metal carbonates, metal bicarbonate, and combinations thereof.

Also disclosed are methods for recycling at least one battery material chosen from a lithium ion battery, lithium ion battery waste, lithium ion battery production scrap, lithium ion cell production scrap, lithium ion cathode active material, and combinations thereof, wherein the methods comprise: optionally, heat treating the at least one battery material at a temperature ranging from 350° C. to 900° C., mechanically comminuting the at least one battery material to obtain a comminuted material, optionally, sorting the comminuted material to obtain a fine fraction (e.g., a black mass) and a coarse fraction, and subjecting the comminuted material, optionally the black mass, the coarse fraction, or the fine fraction and the coarse fraction, to a leaching method disclosed herein.

In some embodiments, the process further comprises smelting the composition comprising copper sulfide.

In some embodiments, the process further comprises roasting the composition comprising copper sulfide.

Also disclosed are compositions comprising copper sulfide prepared according to the methods disclosed herein.

### BRIEF DESCRIPTION OF THE DRAWINGS

FIG. 1 depicts and exemplary batch process consistent with some embodiments of the disclosure.

FIG. 2 depicts and exemplary continuous process consistent with some embodiments of the disclosure.

FIG. 3 depicts an XRD pattern of an exemplary black mass.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, a “reducing agent” is a compound capable of reducing a metal oxide and/or a metal hydroxide. For example, some reducing agents are capable of reducing some metal oxides and/or some metal hydroxides but not others.

As used herein, an “oxidizing agent” is a compound capable of oxidizing a metal in a zero oxidation state. For example, some oxidizing agents are capable of oxidizing some metals in a zero oxidation state but not others.

As used herein, a “solution” is a combination of a fluid and one or more compounds. For example, each of the one or more compounds in the solution may or may not be dissolved in the fluid.

As used herein, an “essentially pure metal ion solution” is a solution comprising a metal ion, a counter ion, a solvent; wherein the total weight of the metal ion and counter ion is at least 50% by weight excluding the weight of solvent.

As used herein, an “essentially pure solid metal ion salt” is a solid comprising a metal ion and a counter ion; wherein the total weight of the metal ion and counter ion is at least 50% by weight of the solid excluding the weight of solvent.

As used herein, the term “sparging” refers to dispersing a gas through a liquid.

As used herein, the term “base” refers to a material capable of reacting with a hydronium ion and to increase the pH-value of an acidic solution.

As used herein, the term “standard electrode potential” has its common usage in the field of electro-chemistry and is the value of the electromotive force of an electrochemical cell in which molecular hydrogen under at 1 bar and 298.15 K is oxidized to solvated protons at the standard hydrogen electrode. The potential of the standard hydrogen electrode is zero Volts by definition. An exemplary reference is: Johnstone, A. H. “CRC Handbook of Chemistry and Physics—69th Edition Editor in Chief RC Weast, CRC Press Inc., Boca Raton, Florida, 1988.

As used herein, the term “smelting” refers to heating a material above its melting temperature, optionally not in the presence of oxygen.

As used herein, the term “roasting” refers to heating a material below its melting temperature, optionally in the presence of oxygen.

As used herein, the term “mixed hydroxide precipitate” refers to a material comprising at least two metal hydroxides. An exemplary mixed hydroxide precipitate is commercially available MHP produced by MCC's (Metallurgical Corporation of China) Ramu plant in PNG (Papua New Guinea) produced according to the following procedure: (1) HPAL (High pressure acid leaching) sulfuric acid leaching of limonite laterite ore fraction, (2) neutralization of the residual acid and Fe/Al removal by precipitation using CaCO₃ to increase the pH, (3) precipitation of the Ni and Co as MHP from the separated PLS using NaOH, and (4) a final precipitation step, using CaO—this 2nd stage precipitate is recycled back to autoclave discharge slurry neutralization, where the Ni and Co (and Mn) re-leaches.

Disclosed are methods for obtaining a composition comprising copper sulfide from a material, wherein the methods comprise: contacting the material with an acidic aqueous solution having a pH less than 6 in the presence of sulfur dioxide to form copper sulfide; wherein the material comprises one or more copper compounds chosen from copper in a zero oxidation state, copper oxide, and copper hydroxide, and wherein the material comprises an amount of zero oxidation state metals having a standard redox-potential less than zero volt versus a standard hydrogen electrode.

### Materials:

The material comprises one or more copper compounds chosen from copper in a zero oxidation state, copper oxide, and copper hydroxide, and the material comprises an amount of zero oxidation state metals having a standard redox-potential less than zero volt versus a standard hydrogen electrode.

In some embodiments, the material is a lithium ion battery material comprising one or more chosen from black mass, cathode active material, cathodes, cathode current collector foils (e.g. comprising aluminum), cathode active material precursors, graphite, anodes, anode current collector foils (e.g. comprising copper), and combinations thereof.

In some embodiments, the material comprises: from 0 weight percent to 10 weight percent lithium, from 0.1 weight percent to 60 weight percent nickel, from 0 weight percent to 20 weight percent cobalt, from 0.1 weight percent to 20 weight percent aluminum, from 0 weight percent to 20 weight percent iron, from 0 weight percent to 20 weight percent manganese, and from 0 weight percent to 20 weight percent zinc; wherein each weight percent is by total weight of the material; wherein an amount of at least one of the nickel, cobalt, aluminum, iron, manganese, and zinc is present as a zero oxidation state metal; and wherein the material has a molar ratio of copper to the amount of zero oxidation state metals having a standard redox-potential less than zero volt versus a standard hydrogen electrode ranging from 1:0.1 to 1:10 (e.g. from 1:1 to 1:5, including, e.g., 1:1.5 or 1:3).

In some embodiments, a material comprises one or more metals in a zero oxidation state and one or more chosen from metal oxides, metal hydroxides, metal carbonates, and combinations thereof.

In some embodiments, the material is a lithium ion battery material comprising one or more chosen from black mass, cathode active material, cathodes, cathode active material precursors, and combinations thereof.

In some embodiments, the material comprises one or more chosen from nickel, cobalt, manganese, and combinations thereof.

In some embodiments, the one or more metals in a zero oxidation state is chosen from nickel, cobalt, copper, aluminum, iron, manganese, rare earth metals, and combinations thereof.

In some embodiments, the metal oxides are chosen from nickel oxides, cobalt oxides, copper oxides, aluminum oxide, iron oxides, manganese oxides, rare earth oxides, and combinations thereof.

In some embodiments, the metal hydroxides are chosen from nickel hydroxides, cobalt hydroxides, copper hydroxides, aluminum hydroxide, iron hydroxides, manganese hydroxides, rare earth hydroxides, and combinations thereof.

In some embodiments, the material comprises: from 0.1 weight percent to 10 weight percent lithium, from 0 weight percent to 60 weight percent nickel, from 0 weight percent to 20 weight percent cobalt, from 0 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material.

In some embodiments, the material, or a precursor thereof, is pyrolyzed prior to leaching. In some embodiments, the pyrolysis is performed under an inert atmosphere, an oxidizing atmosphere, a reducing atmosphere, or a combination thereof.

In some embodiments, the material is a lithium ion battery material comprising one or more chosen from black mass, cathode active material, cathodes, cathode active material precursors, and combinations thereof.

“Black mass” refers to materials comprising lithium derived from, for example, a lithium ion battery, lithium ion battery waste, lithium ion battery production scrap, lithium ion cell production scrap, lithium ion cathode active material, and/or combinations thereof by mechanical processes such as mechanical comminution. For example, black mass may be derived from battery scrap by mechanically treating the battery scrap to obtain the active components of the electrodes such as graphite and cathode active material and may include impurities from the casing, electrode foils, cables, separator, and electrolyte. In some examples, the battery scrap may be subjected to a heat treatment to pyrolyze organic (e.g. electrolyte) and polymeric (e.g. separator and binder) materials. Such a heat treatment may be performed before or after mechanical comminution of the battery material. In some embodiments, the black mass is subjected to a heat treatment.

Lithium ion batteries may be disassembled, punched, milled, for example in a hammer mill, rotor mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D50) ranging from 1 μm to 1 cm, such as from 1 μm to 500 μm, and further for example, from 3 μm to 250 μm.

Larger parts of the battery scrap like the housings, the wiring and the electrode carrier films may be separated mechanically such that the corresponding materials may be excluded from the battery material that is employed in the process.

Mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1% to 99% by weight of water.

In some embodiments, mechanically treated battery scrap may be subjected to a heat treatment in a wide range of temperatures under different atmospheres. In some embodiments, the temperature ranges from 100° C. to 900° C. In some embodiments, lower temperatures below 300° C. may serve to evaporate residual solvents from the battery electrolyte, at higher temperatures the binder polymers may decompose while at temperatures above 400° C. the composition of the inorganic materials may change as some transition metal oxides may become reduced either by the carbon contained in the scarp material or by introducing reductive gases. In some embodiments, a reduction of lithium metal oxides may be avoided by keeping the temperature below 400° C. and/or by removing carbonaceous materials before the heat treatment.

In some embodiments, the heat treatment is performed at a temperature ranging from 350° C. and 900° C. In some embodiments, the heat treatment is performed at a temperature ranging from 450° C. to 800° C. In some embodiments, the heat treatment is performed under an inert, oxidizing, or reducing atmosphere. In some embodiments, the heat treatment is performed under an inert or reducing atmosphere. In some embodiments, reducing agents are formed under the conditions of the heat treatment from pyrolyzed organic (polymeric) components. In some embodiments, reducing agents are formed by adding a reducing gas such as H₂ and/or CO.

In some embodiments, the material comprises at least one chosen from lithiated nickel cobalt manganese oxide, lithiated nickel cobalt aluminum oxide, lithium metal phosphate, lithium ion battery scrap, a black mass, and combinations thereof.

In some embodiments, the material comprises lithium metal phosphate of formula LiₓMPO₄, wherein x is an integer greater than or equal to one, and M is chosen from metals, transition metals, rare earth metals, and combinations thereof.

In some embodiments, the material comprises lithiated nickel cobalt manganese oxide of formula Li₁₊ₓ(NiaCo_{b}Mn_{c}M¹_{d})₁₋ₓO₂, wherein M¹ is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1. Exemplary lithiated nickel cobalt manganese oxides include Li₍₁₊ₓ₎[Ni_{0.33}Co_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.3}]₍₁₋ₓ₎O₂, Li₍₁₊ₓ₎[Ni_{0.5}CO_{0.1}Mn_{0.1}]₍₁₋ₓ₎O₂ each with x as defined above, and Li[Ni_{0.85}Co_{0.13}Al_{0.02}]O₂.

In some embodiments, the material comprises lithiated nickel-cobalt aluminum oxides of formula Li[NiₕCoᵢAlⱼ]O₂₊ᵣ, wherein h ranges from 0.8 to 0.95, i ranges from 0.1 to 0.3, j ranges from 0.01 to 0.10, and r ranges from zero to 0.4.

In some embodiments, the material comprises lithiated manganese oxides of formula Li₍₁₊ₓ₎Mn_{2-x-y-z}M_{y}M′_{z}O₄, wherein x ranges from zero to 0.2; y+z ranges from zero to 0.1; and M′ is chosen from Al, Mg, Fe, Ti, V, Zr and Zn.

In some embodiments, the material comprises a compound of formula xLi_{(1+1/3)}M_{(2/3)}O₂. yLiMO₂. zLiM′O₂, wherein M comprises at least one metal of Mn, Ni, Co of oxidation state +4, M′ is at least one transition metal, and 0<x<1, 0<y<1, 0<z<1 and x+y+z=1.

In some embodiments, the material comprises nickel, cobalt, manganese, copper, aluminum, iron, phosphorus, or combinations thereof.

In some embodiments, wherein the material has a weight ratio ranging from 0.01 to 10 of lithium to a total weight of nickel, cobalt, manganese, copper, aluminum, iron, and phosphorus. In some embodiments, wherein the material has a weight ratio ranging from 0.01 to 5 of lithium to a total weight of nickel, cobalt, manganese, copper, aluminum, iron, and phosphorus. In some embodiments, wherein the material has a weight ratio ranging from 0.01 to 2 of lithium to a total weight of nickel, cobalt, manganese, copper, aluminum, iron, and phosphorus. In some embodiments, wherein the material has a weight ratio ranging from 0.01 to 1 of lithium to a total weight of nickel, cobalt, manganese, copper, aluminum, iron, and phosphorus.

In some embodiments, the material comprises LiₓMO₂ wherein x is an integer greater than or equal to one, and M is chosen from metals, transition metals, rare earth metals, and combinations thereof.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass.

In some embodiments, the material has a standard electrode potential ranging from +1.1 V to −1.7 V. In some embodiments, from 0.1 weight % to 10 weight % of the material has a standard electrode potential ranging from +0.1 V to +0.8 V and from 0.1 weight % to 60 weight % of the material has a standard electrode potential ranging from −1.7 V to −0.01 V; by total weight of the material.

In some embodiments, the one or more metals in a zero oxidation state each have a standard electrode potential ranging from 1.1 V to −1.7 V. In some embodiments, the one or more metals in a zero oxidation state each have a standard electrode potential ranging from −1.7 V to +0.35 V. Standard electrode potentials for some exemplary metals in a zero oxidation state include: Al/Al³⁺(E(0)=−1.66 V), Cu/Cu²⁺(E(0)=+0.35 V), Co/Co²⁺(E(0)=−0.28 V), Fe/Fe²⁺(E(0)=−0.44 V), and Ni/Ni²⁺(E(0)=−0.23 V).

In some embodiments, the one or more chosen from metal oxides, metal hydroxides, and combinations thereof each have a standard electrode potential ranging from +0.1 V to +1.9 V. In some embodiments, the one or more chosen from metal oxides, metal hydroxides, and combinations thereof each have a standard electrode potential ranging from 0.15 V to 1.83 V. Standard electrode potentials for some exemplary metal ions such as, for example, metal ions that may result from the dissolution of oxides or hydroxides, and metal oxides and/or metal hydroxides include: Co³⁺/Co²⁺(E(0)=+1.83 V), NiO₂+4H⁺/Ni²⁺+2H₂O (E(0)=+1.678 V), Mn³⁺/Mn²⁺(E(0)=+1.5415 V), and Mn(OH)₃/Mn(OH)₂+OH— (E(0)=+0.15 V).

### Methods:

Disclosed are methods for obtaining a composition comprising copper sulfide from a material, wherein the methods comprise: contacting the material with an acidic aqueous solution having a pH less than 6 in the presence of sulfur dioxide to form copper sulfide; wherein no oxidizing agent is added during the contacting step; wherein the material comprises one or more copper compounds chosen from copper in a zero oxidation state, copper oxide, and copper hydroxide, and wherein the material comprises an amount of zero oxidation state metals having a standard redox-potential less than zero volt versus a standard hydrogen electrode.

In some embodiments, the method further comprises separating the composition comprising copper sulfide from the aqueous solution by a solid-liquid separation (e.g., filtration, sedimentation, and/or centrifugation).

In some embodiments, the method further comprising purifying the composition comprising copper sulfide by a solid-solid separation (e.g., flotation, magnetic separation employing magnetic carrier particles capable of forming magnetic agglomerates with the copper sulfide particles, gravity separation and/or dense media separation).

No oxidizing agent is added during the contacting step. In particular, no air, O₂, or NO₂ are added during the contacting step. Contacting the material with an acidic aqueous solution having a pH less than 6 in the presence of sulfur dioxide causes formation of hydrogen gas by reaction of the acid with the zero oxidation state metals having a standard redox-potential less than zero volt versus a standard hydrogen electrode which are present in the material. Reaction of the hydrogen gas formed with sulfur dioxide in turn causes formation of hydrogen sulfide, which then reacts with copper present in the material to form copper sulfide. The presence of oxidizing agents capable of oxidizing hydrogen or preventing the reduction of sulfur dioxide to sulfide therefore would be detrimental, and the addition of oxidizing agents during the contacting step should be avoided until after the hydrogen gas formation, i.e., after the copper sulfide has been formed.

In some embodiments of the method, the acidic aqueous solution is not sparged with an oxidizing agent (e.g., air) prior to the contacting step.

Contacting the material with an acidic aqueous solution having a pH less than 6 comprises first contacting the material with an acid in the presence of sulfur dioxide causing a formation of hydrogen gas and the formation of hydrogen sulfide gas.

In some embodiments, contacting the material with an acidic aqueous solution having a pH less than 6 causes a formation of hydrogen gas, and the acidic aqueous solution having a pH less than 6 is contacted with sulfur dioxide during the formation of hydrogen gas.

In some embodiments, the SO₂ is purged through the solution at a rate of up to 20% solution volume/min for 1 hour to 3 hours. The SO₂ is not provided as a mixture with O₂ or air. In some embodiments, the SO₂ is provided as pure gas having a purity of at least 90%, for example 99%, or as mixture with an inert gas such as, for example, nitrogen and/or argon.

In some embodiments, excess sulfur dioxide is recycled from the off-gas back into the reactor.

In some embodiments, the contacting step is performed at ambient temperature. In some embodiments, the contacting step is performed at a temperature ranging from 50° C. to 110° C. In some embodiments the contacting step is performed for a duration ranging from 2 hours to 4 hours.

In some embodiments, the acidic aqueous solution has a pH ranging from −1.0 to 3.

In some embodiments, the method comprises an oxidation step during which an oxidizing agent is added to the acidic aqueous solution and the oxidation step is subsequent to the contacting step. In some embodiments, the acidic aqueous solution is not sparged with air prior to the contacting step. In some embodiments, no oxidizing agent other than sulfuric acid is added to the acidic aqueous solution prior to the contacting step.

In some embodiments, a mixture of SO₂ with O₂ or air containing 5% SO₂ or more is used as an oxidizing agent. In some embodiments, excess oxidizing gas O₂, such as in air, and/or N₂O is recycled from the off-gas back into the leaching reactor.

In some embodiments of the method, no oxidizing agent is added until after the hydrogen gas formation. In some embodiments, no oxidizing agent is added until at least 1 minute, at least 10 minutes, at least 30 minutes, at least 1 hour, or at least 2 hours, after the beginning of the contacting step.

In some embodiments, a black mass is slurred in water at a weight percentage of black mass by total weight of the slurry ranging from 5% to 30%. In some embodiments, the slurred black mass is contacted with the acidic aqueous solution having a pH less than 6. In some embodiments, the acidic aqueous solution having a pH less than 6 is formed from the slurred black mass by addition of acid and/or an oxidizing agent. In some embodiments, the weight ratio of H₂SO₄ in the acidic aqueous to black mass ranges from 1:1 to 2:1. In some embodiments, H₂SO₄ is added to adjust the pH during the contacting step.

In some embodiments, the black mass is provided as a slurry. In some embodiments, the black mass is provided as a slurry in water. In some embodiments, the black mass is provided as a slurry in aqueous side streams from subsequent treatment steps such as, for example, washing liquids from filters. In some embodiments, the black mass is provided as a solid. In some embodiments, the cathode active material is provided as a slurry. In some embodiments, the cathode active material is provided as a slurry in water. In some embodiments, the cathode active material is provided as a slurry in aqueous side streams from subsequent treatment steps such as, for example, washing liquids from filters. In some embodiments, the cathode active material is provided as a solid. In some embodiments, the mixed hydroxide precipitate is provided as a slurry. In some embodiments, the mixed hydroxide precipitate is provided as a slurry in water. In some embodiments, the mixed hydroxide precipitate is provided as a slurry in aqueous side streams from subsequent treatment steps such as, for example, washing liquids from filters. In some embodiments, the mixed hydroxide precipitate is provided as a solid.

In some embodiments zero oxidation state metals having a standard redox-potential less than zero volt versus a standard hydrogen electrode are added to the material prior or during the contacting the material with acid. Such metals may comprise, for example, nickel, cobalt, manganese, iron, zinc, and/or aluminum.

In some embodiments, if the material comprises battery materials derived from nickel containing batteries, nickel is added.

In some embodiments, if the material comprises battery materials derived from cobalt containing batteries, cobalt is added.

In some embodiments, if the material comprises battery materials derived from manganese containing batteries, manganese is added.

In some embodiments, if the material comprises battery materials derived from iron (e.g. lithium iron phosphate) containing batteries, iron is added.

In some embodiments, subsequent to the contacting step, the method further comprises adding a base. In some embodiments, the base is chosen from CaO, a hydroxide salt, a carbonate salt, and combinations thereof. In some embodiments, the hydroxide salt is chosen from LiOH, NaOH, KOH, NH₄OH, Ca(OH)₂, CaCO₃, Ni(OH)₂, Co(OH)₂, Mn(OH)₂, and combinations thereof. In some embodiments, the hydroxide salt is a mixed hydroxide precipitate obtained from nickel laterite ore processing.

In some embodiments, the method is performed batchwise.

In some embodiments, the method is performed continuously in at least two reaction vessels. In some embodiments, the method is performed continuously in, e.g., three, four, five, six, seven, or more reaction vessels. In some embodiments, the black mass is added to a first reaction vessel, the oxidizing agent is added to a second and/or a third reaction vessel, the cathode active material and/or mixed hydroxide precipitate is added to a fourth reaction vessel, and the reducing agent is added to a fourth, a fifth, and/or a sixth reaction vessel.

In some embodiments, a reflux condenser is fitted to at least one reaction vessel.

In some embodiments, contacting the material with an acidic aqueous solution is carried out at ambient pressure. In some embodiments, the contacting the material with an acidic aqueous solution is carried out at an elevated pressure.

In some embodiments, the contacting step is at a temperature ranging from 20° C. to 100° C. for a duration ranging from 10 minutes to 10 hours. In some embodiments, the contacting step is at 100° C. for a duration ranging from 3 hours to 5 hours. In some embodiments, the contacting step is at 60° C. for a duration ranging from 3 hours to 5 hours. In some embodiments, the contacting step is at 25° C. for a duration ranging from 3 hours to 5 hours.

In some embodiments, a disclosed method comprises leaching a material according to a method disclosed herein to obtain an aqueous solution comprising metal ions and separating the metal ions to obtain at least one essentially pure metal ion solution and/or at least one essentially pure solid metal ion salt.

In some embodiments, an essentially pure solid metal ion salt is a solid comprising a metal ion and a counter ion; wherein the total weight of the metal ion and counter ion is at least 50% by weight of the solid excluding the weight of solvent such as all water. In some embodiments, an essentially pure solid metal ion salt is a solid comprising a metal ion and a counter ion; wherein the total weight of the metal ion and counter ion is at least 70% by weight of the solid excluding the weight of solvent. In some embodiments, an essentially pure solid metal ion salt is a solid comprising a metal ion and a counter ion; wherein the total weight of the metal ion and counter ion is at least 80% by weight of the solid excluding the weight of solvent. In some embodiments, an essentially pure solid metal ion salt is a solid comprising a metal ion and a counter ion; wherein the total weight of the metal ion and counter ion is at least 90% by weight of the solid excluding the weight of solvent. In some embodiments, an essentially pure solid metal ion salt is a solid comprising a metal ion and a counter ion; wherein the total weight of the metal ion and counter ion is at least 95% by weight of the solid excluding the weight of solvent. In some embodiments, an essentially pure solid metal ion salt is a solid comprising a metal ion and a counter ion; wherein the total weight of the metal ion and counter ion is at least 99% by weight of the solid excluding the weight of solvent.

In some embodiments, an essentially pure metal ion solution is a solution comprising a metal ion, a counter ion, and a solvent; wherein the total weight of the metal ion and counter ion is at least 50% by weight of the solution excluding the weight of solvent. In some embodiments, an essentially pure metal ion solution is a solution comprising a metal ion, a counter ion, a solvent; wherein the total weight of the metal ion and counter ion is at least 70% by weight of the solution excluding the weight of solvent. In some embodiments, an essentially pure metal ion solution is a solution comprising a metal ion, a counter ion, a solvent; wherein the total weight of the metal ion and counter ion is at least 80% by weight of the solution excluding the weight of solvent. In some embodiments, an essentially pure metal ion solution is a solution comprising a metal ion, a counter ion, a solvent; wherein the total weight of the metal ion and counter ion is at least 90% by weight of the solution excluding the weight of solvent. In some embodiments, an essentially pure metal ion solution is a solution comprising a metal ion, a counter ion, a solvent; wherein the total weight of the metal ion and counter ion is at least 95% by weight of the solution excluding the weight of solvent. In some embodiments, an essentially pure metal ion solution is a solution comprising a metal ion, a counter ion, a solvent; wherein the total weight of the metal ion and counter ion is at least 99% by weight of the solution excluding the weight of solvent.

In some embodiments, separating the metal ions to obtain at least one essentially pure metal ion solution and/or at least one essentially pure solid metal ion salt comprises one or more of a solid/liquid separation, an extraction, a precipitation, a crystallization, and combinations thereof.

In some embodiments, the method can be performed in part or in whole as a continuous process controlled by sensors and actuators as part of a computer based process control system.

In some embodiments, the method the process further comprises smelting the composition comprising copper sulfide.

In some embodiments, the process further comprises roasting the composition comprising copper sulfide.

### Compositions Comprising Copper Sulfide:

Disclosed herein are compositions comprising copper sulfide.

In some embodiments, the composition comprising copper sulfide is prepared according to a process disclosed herein.

In some embodiments, the compositions comprising copper sulfide comprises copper-(II)-sulfide CuS and/or copper-(I)-sulfide Cu₂S. In some embodiments the composition comprising copper sulfide comprises also copper metal and sulfur.

In some embodiments the copper sulfide species are amorphous.

In some embodiments, the compositions comprising copper sulfide comprises from 2.5 weight % to 100 weight % copper sulfide by total weight of the composition. In some embodiments, the compositions comprising copper sulfide comprises from 10 weight % to 100 weight % copper sulfide by total weight of the composition. In some embodiments, the compositions comprising copper sulfide comprises from 25 weight % to 100 weight % copper sulfide by total weight of the composition. In some embodiments, the compositions comprising copper sulfide comprises from 2.5 weight % to 30 weight % copper sulfide by total weight of the composition. In some embodiments, the compositions comprising copper sulfide comprises from 10 weight % to 30 weight % copper sulfide by total weight of the composition. In some embodiments, the compositions comprising copper sulfide comprises from 25 weight % to 50 weight % copper sulfide by total weight of the composition.

In some embodiments, the composition comprising copper sulfide is separated from the aqueous solution by a solid-liquid separation. In some embodiments, the composition comprising copper sulfide is separated from the aqueous solution by at least one solid-liquid separation chosen from filtration, sedimentation, and centrifugation.

In some embodiments, one or more value metals are separated by solvent extraction. In some embodiments, one or more of Ni, Co, Mn, Cu, and Li are extracted by solvent extraction from the separated liquid.

In some embodiments, the composition comprising copper sulfide is purified by a solid-solid separation. In some embodiments, the composition comprising copper sulfide is purified by at least one solid-solid separation chosen from flotation, magnetic separation, gravity separation, and dense media separation.

In some embodiments, copper sulfide in the leaching residue is separated by flotation in the presence of a xanthate, a dithiophosphate, a thionocarbamate, a xanthogen formate, a xanthic ester, and/or a mercaptobenzothiazol collector.

In some embodiments, the carbon contained in the leaching residue is separated by flotation in the presence of hydrophobic oils as collectors, e.g. alkanes with more than seven carbon atoms.

In some embodiments, the carbon material is first floated employing a hydrophobic oil as a collector and secondly the copper sulfide is floated by employing a xanthate, a dithiophosphate, a thionocarbamate xanthogen formate, a xanthic ester, and/or a mercaptobenzothiazol collector.

In some embodiments the copper sulfide is first floated by employing a xanthate, a dithiophosphate, a thionocarbamate xanthogen formate, a xantthic ester, and/or a mercaptobenzothiazol collector, and the carbon material is secondly floated employing a hydrophobic oil as collector.

PCT international application no. PCT/EP2008/061503, filed Sep. 1, 2008, provides an exemplary magnetic separation process. The disclosure of PCT international application no. PCT/EP2008/061503, filed Sep. 1, 2008, is incorporated by reference herein in its entirety.

Exemplary processes for separating and purify compositions comprising copper sulfide are provided in Appl, M. “Ullmann s Encyclopedia of Industrial Chemistry 2011.” DOI 10.1002 (2012): 14356007; which is incorporated by reference herein in its entirety.

### Oxidizing Agents:

In some embodiments, the oxidizing agent comprises O₂. In some embodiments, the oxidizing agent is air.

In some embodiments, an oxidizing agent has a standard electrode potential ranging from +0.1 V to +1.8 V. In some embodiments, an oxidizing agent has a standard electrode potential ranging from +0.4 V to +1.3 V. In some embodiments, an oxidizing agent has a standard electrode potential ranging from +1 V to +1.5 V.

### Reducing Agents:

In some embodiments, a reducing agent has a standard electrode potential ranging from +1 V to −0.5 V. In some embodiments, a reducing agent has a standard electrode potential ranging from +0.2 V to −0.3 V.

Hydrogen peroxide can function as reductant or oxidant, depending on the reaction partner. Possible oxidation and reduction reactions are: H₂O₂→O₂+2e⁻+2 H⁺, and H₂O₂+2e⁻+2 H⁺→2 H₂O. In some embodiments, the standard electrode potential of the reaction partner impacts which reaction occurs. For example, under certain conditions permanganate (MnO₄) is reduced by hydrogen peroxide while Fe²⁺ is oxidized. In some embodiments, more acidic conditions benefit the oxidation reaction as H⁺ is needed to form water and less acidic conditions benefit the reduction reaction as H⁺ is produced during that reaction. In some embodiments, the following reactions may or may not occur depending on the one or more metals M and the conditions used: 2LiMO₂+H₂O₂+3H₂SO₄→2LiSO₄+2MSO₄+4H₂O+O₂, and M+H₂O₂+H₂SO₄→MSO₄+2H₂O.

### Exemplary Batch Process:

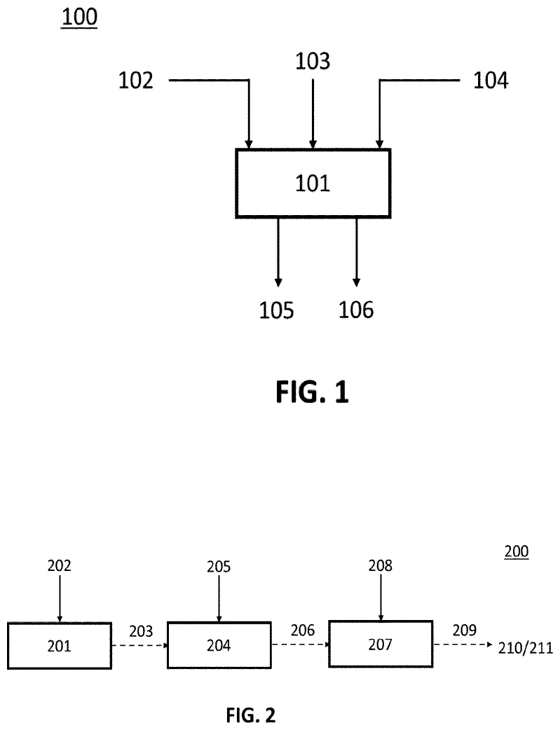

FIG. 1 depicts and exemplary batch process (100) consistent with some embodiments of the disclosure. In some embodiments, a material (102) such as a black mass comprising nickel, cobalt, copper, and manganese species is acid leached in a continuously stirred reaction vessel (101) comprising an acidic aqueous solution at a pH less than 0. In some embodiments, hydrogen gas is evolved (105) and SO₂ is added (103) during the hydrogen gas evolution. In some embodiments, the pH is adjusted up to a pH ranging from 1 to 2 with, for example, cathode active material and/or mixed hydroxide precipitate and an oxidizing agent such as, for example, O₂ and/or N₂O is added (104). In some embodiments, the obtained liquid phase (106) and a solid phase (105) are separated by a solid/liquid separation e.g. filtration, centrifugation, and/or sedimentation.

### Exemplary Continuous Process:

FIG. 2 depicts and exemplary continuous process (200) consistent with some embodiments of the disclosure. In some embodiments, a material (202) such as a black mass comprising nickel, cobalt, copper, and manganese species is acid leached in continuously stirred reaction vessel (201) comprising an acidic aqueous solution at a pH less than 0. In some embodiments, the acid leaching is further carried out in one or more additional continuously stirred reaction vessels (203). In some embodiments, SO₂ is added (205) to a continuously stirred reaction vessel (204). In some embodiments, the acid leaching in the presence of an added oxidizing agent is further carried out in one or more additional continuously stirred reaction vessels (206). In some embodiments, the pH is adjusted up to a pH ranging from 1 to 2 with, for example, cathode active material and/or mixed hydroxide precipitate and, in some embodiments, an oxidizing agent such as, for example, O₂ and/or N₂O is introduced (208) to a continuously stirred reaction vessel (207). In some embodiments, the leaching in the presence of an added oxidizing agent is further carried out in one or more additional continuously stirred reaction vessels (209). In some embodiments, the obtained liquid phase (211) and a solid phase (210) are separated by a solid/liquid separation e.g. filtration, centrifugation, and/or sedimentation.

In some embodiments of the method, at the beginning of the contacting step, less than 50 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode. In some embodiments, at the beginning of the contacting step, less than 25 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode. In some embodiments, at the beginning of the contacting step, less than 10 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode. In some embodiments, at the beginning of the contacting step, less than 1 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode.

In some embodiments of the method, no oxidizing agent is added during the contacting step.

In some embodiments of the method, a subsequent oxidation step involving the addition of air begins at least 1 minute after the contacting step begins, at least 10 minutes after the contacting step begins, at least 30 minutes after the contacting step begins, or at least 1 hour after the contacting step begins. In some embodiments, the subsequent oxidation step begins from 0 minutes to 2 hours after the contacting step begins.

In some embodiments of the method, the composition comprising copper sulfide is separated by flotation in the presence of a xanthate, a dithiophosphate, a thionocarbamate xanthogen formate, a xanthic ester, and/or a mercaptobenzothiazol collector.

In some embodiments, the method comprises leaching a material to obtain an aqueous solution comprising metal ions and separating the metal ions to obtain at least one essentially pure metal ion solution and/or at least one essentially pure solid metal ion salt.

In some embodiments of the method, contacting the material with the acidic aqueous solution having a pH less than 6 causes a formation of hydrogen gas, and the acidic aqueous solution having a pH less than 6 is contacted with the sulfur dioxide during the formation of hydrogen gas.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

### EXAMPLES

The following examples are intended to be illustrative and are not meant in any way to limit the scope of the disclosure.

Abbreviations

| | |
|---|---|
| % | percent |
| g/t | grams per ton |
| K₂CO₃ | potassium carbonate |
| Na₂CO₃ | sodium carbonate |
| Na₂B₄O₇ | sodium tetraborate |
| p.a. grade | pro analysis grade |
| n.d. | not determined |
| wt % | weight percent |
| NaOH | sodium hydroxide |
| Li | lithium |
| Ni | nickel |
| Co | cobalt |
| Mn | manganese |
| Cu | copper |
| Al | aluminum |
| Fe | iron |
| P | phosphorus |
| F | fluorine |
| Ca | calcium |

### Exemplary Elemental Analysis

Elemental analysis of solid samples was done by digestion in nitric acid and hydrochloric acid (feed samples and Examples 1 and 2) or digestion by K₂CO₃—Na₂CO₃/Na₂B₄O₇ fusion and dissolution of the fusion residue in hydrochloric acid (Examples 3 and 4).

The metals within the obtained sample solutions were determined by optical emission spectroscopy using an inductively coupled plasma (ICP-OES).

Some elemental concentrations were also measured by X-ray fluorescence employing an Epsilon 4 DY-6024 from Malvern Panalytical using the Malvern Panalytical Omnian Software.

Elemental analysis of fluorine and fluoride was performed in accordance with DIN EN 14582:2016-12 with regard to the sample preparation for the overall fluorine content determination (waste samples); the detection method was an ion selective electrode measurement. DIN 38405-D4-2:1985-07 (water samples; digestion of inorganic solids with subsequent acid-supported distillation and fluoride determination using ion selective electrode).

Total carbon was determined by gas chromatography with a thermal conductivity detector of the gases obtained after combustion of the samples.

Sulfur was determined by catalytical combustion of the sample in an inert gas/oxygen atmosphere the sulfur is hereby converted to a mixture of SO₂ and SO₃. The formed SO₃ was subsequently reduced to SO₂ with copper granules. After drying and separation of the combustion gases, sulfur was detected and quantified as SO₂ via thermal conductivity or IR spectrometry.

### Black Mass

For the Examples provided below, a black mass was obtained by mechanical comminution of lithium ion batteries and subsequent separation of the black mass as a fine powder from the other constituents of the lithium ion batteries. The black mass was obtained by a process involving a pyrolysis of battery scrap. The material contains low amounts of sulfur. The metals analyzed are present as oxidic compounds like MnO, CoO, NiO, as salts like LiF, LiAIO₂, Li₂CO₃, and/or as zero oxidation state metals like nickel, cobalt, and copper. The carbon is elemental carbon mainly in the form of graphite with some soot or coke.

The composition of the black mass used in Examples 1 and 2 is provided in Table 1.

TABLE 1
Composition of black mass used in Examples 1 and 2.

| | Weight |
|---|---|
| Element | Percent |
| Al | 6.3% |
| Ca | 0.1% |
| Co | 6.6% |
| Cu | 4.2% |
| Fe | 2.3% |
| K | 0.023% |
| Li | 3.5% |
| Mg | 0.16% |
| Mn | 7.0% |
| Na | 0.049% |
| Ni | 10.6% |
| Ti | 0.011% |
| Zn | 0.017% |
| F | 2.8% |

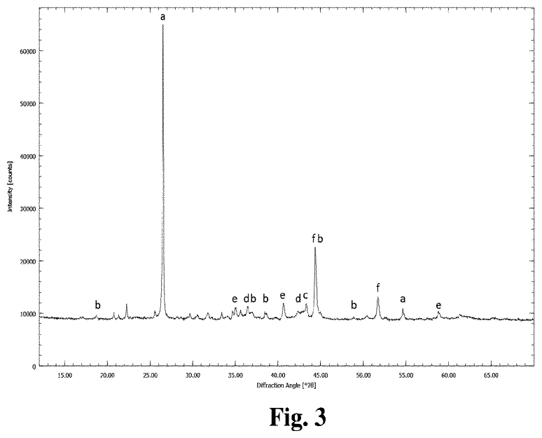

FIG. 3 depicts an XRD pattern of the black mass. In FIG. 3, “a” indicates graphite, “b” indicates nickel-cobalt-manganese, “c” indicates NiO, “d” indicates CoO, “e” indicates MnO, “f” indicates Ni, and the remaining reflections correspond to lithium salts and impurities.

The composition of the black mass used in Example 3 is given in Table 2.

TABLE 2
Composition of Black Mass used in Example 3:
Weight % of Element

| Ni | Co | Mn | Li | Al | Fe | Cu | C | F | S |
|---|---|---|---|---|---|---|---|---|---|
| 21.5 | 5.9 | 0.34 | 3.5 | 4.2 | 0.3 | 4.1 | 38.1 | 2.0 | 0.05 |

### Cathode Active Material

The cathode active material (CAM) used in Examples 1 and 2 was a commercially available CAM from BASF Corp called HED™ NCM the composition of which was: 49.8 weight % Ni, 5.9 weight % Co, 2.6 weight % Mn, and 7.3 weight % Li.

### Example 1

In this example, the black mass of Table 1 was contacted with an oxidizing acidic aqueous solution having a pH less than 6, and subsequently reduced with a reducing agent.

In a baffled 0.75 L jacketed reactor flushed with argon 174.13 g black mass was suspended in 337.21 g of water. Then, 243.78 g of H₂SO₄ (96 wt %) was slowly added within 55 min while stirring. The slurry was heated during the acid addition to 90° C. After the end of the acid addition the reactor content was kept at 90° C. for additional 110 min until the evolution of hydrogen gas has ceased. Then air was sparged through the solution for 2.5 hours at 20 normal liters per hour (NIph) while maintaining a slurry temperature of about 80° C. After additional 30 min 25 g of cathode active material was added. The reactor was kept for additional 234 min under air. Subsequently, SO₂ was sparged through the solution at 1.8 NIph for 51 min. The composition of the leach residue is provided in Table 4.

TABLE 4
Composition of leach residue from Example 1.

| Element | Concentration |
|---|---|
| Al | 3.2% |
| Co | 0.48% |
| Cu | 0.19% |
| Fe | 0.31% |
| Li | 0.14% |
| Mn | 0.23% |
| Ni | 0.73% |
| F | 0.4% |

The recovery of each of the elements Ni, Co, Mn, and Li was 98.2%, 98.1%, 99.2% and 99.0% respectively. The recovery of Cu was 98.7% based on the analysis of the washed and dried leach residue.

### Example 2

In this example, black mass with the composition shown in Table 1 was leached with sulfuric acid without introducing air as oxidant but in the presence of sulfur dioxide.

In a reaction vessel, 205 g of black mass and 25 g cathode active material were suspended in 563 g of de-ionized water under an atmosphere of argon. To this mixture, 266 g of sulfuric acid (96 wt %) was slowly added over a period of about 45 min under vigorous stirring with a Rushton turbine. Simultaneously, sulfur dioxide was fed to the reactor with a rate of 2.7 g/h. The gas leaving the reactor was fed to a scrubber filled with 1779 g of a solution of 50 g copper-(II)-sulfate pentahydrate in 1729 g of water. After the acid addition, the reactor was heated to 96° C. within 40 min. The reactor was kept at this temperature for an additional 205 min. Next, the sulfur dioxide addition was stopped and the reactor was cooled to ambient temperature. The reactor content was filtered, washed with water, and dried to yield 61.65 g of a black solid. 65 min after the start of the sulfuric acid and sulfur dioxide addition, the initially blue copper sulfate solution in the scrubber started to turn greenish and a dark precipitate was formed. The precipitate of the scrubber was also filtered washed with water and dried to yield 0.116 g of a dark solid. The analyses of the solid residues are given in Table 7.

TABLE 7
Composition of dried solid residues

| | Weight % of Element | | | | | | | | |
|---|---|---|---|---|---|---|---|---|---|
| | Ni | Co | Mn | Li | Al | Fe | Cu | C | S |
| Reactor | 0.34 | 0.28 | 0.19 | 0.19 | 3.3 | 0.11 | 12.5 | 79 | 4.1 |
| residue | | | | | | | | | |
| Scrubber | | | | | | | 83 | | 17 |
| residue | | | | | | | | | |

The data in Table 7 shows that an insoluble sulfur containing phase was formed during the reaction which was not present in the feed black mass (Table 2). The molar ratio of Cu:S in the reactor product was 3:2. The molar ratio of Cu:S in the scrubber product was about 12:5. Without wishing to be bound by theory, it is believed that under the reducing conditions in the presence of sulfur dioxide a mixture of copper-(II)-sulfide CuS and copper-(I)-sulfide Cu₂S was formed in the reactor. The scrubber product was Cu₂S with some adsorbed copper sulfate which could explain the excess copper. The amount of copper in the filter residue of the reaction mixture corresponds to about 92% of the copper. In this filter residue copper-(I)-sulfide was identified by reflection at 26 of 27.8°, 46.3° and 54.6° by XRD analysis. These reflections are slightly shifted to higher values compared to pure copper-(I)-sulfide, indicating a sub-stoichiometric composition.

### Example 3

In this example, example 2 was repeated with 186 g of the black mass according to Table 2 and 21 g of cathode active material.

The black mass and NCM were suspended in 588 g of deionized water. This suspension was stirred at 700 rpm and 228 g of sulfuric acid (96 wt %) were slowly added over 52 min. In parallel to the acid addition, sulfur dioxide gas was introduced to the reactor with a rate of 3 g/h. During the acid addition the reactor temperature rose to 52° C. After the end of the acid addition, the reactor temperature was heated to 100° C. which was reached 90 min after the end of the acid addition. The sulfur dioxide addition was kept until the end of the trial 282 min after the start of the sulfuric acid/sulfur dioxide addition. The reactor was flushed with argon and the suspension was diluted with 199.4 g of deionized water. The cooled suspension was filtered and the filter residue washed with deionized water. The composition of the dried filter cake is given in Table 8.

TABLE 8
Composition of dried solid residues (XRF analysis).

| | Weight % of Element | | | | | | | | |
|---|---|---|---|---|---|---|---|---|---|
| | Ni | Co | Mn | Li | Al | Fe | Cu | C | S |
| Reactor | 8.3 | 1.5 | 0.07 | — | 7.5 | 0.03 | 9.4 | 70 | 1.6 |
| residue | | | | | | | | | |

Although the recoveries of Ni and Co were lower compared to Example 2, this residue was then subjected to a flotation to separate the Cu-sulfide. The flotation proceeded as follows.

80 g of the dried residue was dispersed in a 2 L-Denver flotation cell with 800 g deionized water by 15 min stirring at 1200 rpm with closed gas inlet valve. Then 5000 g/t solid Shellsol D40, a hydrogenated C11-C13 hydrocarbon, was added as graphite collector and dispersed for another 5 min at 1200 rpm. Then 200 g/t solid methyl isobutyl carbinol (MIBC) was added and stirred for another 5 min. Afterwards, 270 g water was added and the gas inlet valve was opened and the flotation started at an air flow rate of about 150 L/h. After 10 min, the flotation was stopped by closing the gas inlet valve again (1^{st} froth). Now 200 g/t initial solid of potassium ethyl hexyl xanthate was added and stirred for 10 min at 1200 rpm. An additional 200 g/t of initial solid of MIBC was added and then the gas inlet valve was opened again. Next, another 10 min flotation was performed (2^{nd} froth). The data in Table 9 summarizes the composition and yields of the two flotation stages.

TABLE 9
Composition of dried solid flotation fractions (XRF analysis) (recoveries).

| | Mass | Weight % of Element by total weight of the Fraction | | | | | | | | |
|---|---|---|---|---|---|---|---|---|---|---|
| Fraction | pull % | Ni | Co | Mn | Li | Al | Fe | Cu | C | S |
| 1^{st} Froth | 81.9 | 4.9 | 0.9 | 0.02 | — | 3.1 | 0.02 | 7.7 | 81 | 1.3 |
| (concentrate) | | (48) | (49) | | | | | (67) | (95) | (66) |
| 2nd Froth | 2.5 | 12.2 | 2.2 | 0.05 | — | 10.7 | 0.05 | 22.5 | 43 | 6.8 |
| (concentrate) | | (4) | (4) | | | | | (6) | (2) | (11) |
| Final tailings | 11.8 | 23.7 | 4.2 | 0.1 | — | 23.0 | 0.08 | 8.7 | 31 | 2.3 |
| | | (34) | (33) | | | | | (11) | (5) | (17) |

In Table 9, under the “Weight % of Element by total weight of the Fraction” heading, the numbers without brackets are the grades of the elements in the fractions, and the numbers in brackets are the recoveries of the elements. For example, in the 1st froth obtained with the Shellsol collector, the grade is 7.7% Cu and the recovery (67%). In the 2nd froth fraction obtained with xanthate collector, for example, the Cu grade is 22.5% and the recovery only (6%). The final tailings is the residual material which is left after the two consecutive flotation stages: the 1st with Shellsol as collector for carbon which also catches the Cu and the 2nd with xanthate specific for sulfide minerals catching Cu sulfide. In Table 9, mass pull is the total mass of solids recovered in the fraction divided by the mass of solid feed. This exemplary flotation experiment demonstrates that copper can be enriched.

Comparing Example 1 with Examples 2 and 3, it is believed that simultaneous reduction with SO₂ at the contacting step, as opposed to, for example, subsequent reduction with SO₂ after an oxidation step (such as with air added as an oxidizing agent) and/or a combined oxidation/reductions step with concurrent addition of air and SO₂, may result in formation of copper-(II)-sulfide CuS and/or copper-(I)-sulfide Cu₂S. One may separate such copper sulfide compositions from the aqueous solution by a solid-liquid separation such as, for example, filtration, sedimentation, and/or centrifugation. One may purify such copper sulfide compositions by a solid-solid separation such as, for example, flotation, magnetic separation employing magnetic carrier particles capable of forming magnetic agglomerates with the copper sulfide particles, gravity separation, and/or dense media separation.

1. A method for obtaining a composition comprising copper sulfide from a material, wherein the method comprises:
contacting the material with an acidic aqueous solution having a pH less than 6 in the presence of sulfur dioxide to form copper sulfide;
wherein no oxidizing agent is added during the contacting step;
wherein the material comprises one or more copper compounds selected from the group consisting of copper in a zero oxidation state, copper oxide, and copper hydroxide; and
wherein the material comprises an amount of zero oxidation state metals having a standard redox-potential less than zero volt versus a standard hydrogen electrode.

2. The method according to claim 1, further comprising separating the composition comprising copper sulfide from the aqueous solution by a solid-liquid separation.

3. The method according to claim 1, further comprising purifying the composition comprising copper sulfide by a solid-solid separation.

4. The method according to claim 2, wherein the composition comprises from 0.1 weight percent to 100 weight percent of copper sulfide; by total weight of the composition.

5. The method according to claim 1, wherein the acidic aqueous solution comprises H₂SO₄.

6. The method according to claim 1, wherein the material is a lithium ion battery material selected from the group consisting of black mass, cathode active material, cathodes, cathode current collector foils, cathode active material precursors, graphite, anodes, anode current collector foils, and combinations thereof.

7. The method according to claim 1, wherein the material comprises:
from 0 weight percent to 10 weight percent lithium,
from 0.1 weight percent to 60 weight percent nickel,
from 0 weight percent to 20 weight percent cobalt,
from 0.1 weight percent to 20 weight percent aluminum,
from 0 weight percent to 20 weight percent iron,
from 0 weight percent to 20 weight percent manganese, and
from 0 weight percent to 20 weight percent zinc;
wherein each weight percent is by total weight of the material;
wherein an amount of at least one of the nickel, cobalt, aluminum, iron, manganese, and zinc is present as a zero oxidation state metal; and
wherein the material has a molar ratio of copper to the amount of zero oxidation state metals having a standard redox-potential less than zero volt versus a standard hydrogen electrode ranging from 1:0.1 to 1:10.

8. The method according to claim 1, wherein the material, or a precursor thereof, is pyrolyzed prior to the contacting step.

9. The method according to claim 1, wherein contacting the material with an acidic aqueous solution having a pH less than 6 in the presence of sulfur dioxide causes a formation of hydrogen gas and hydrogen sulfide gas, and wherein after the formation of hydrogen gas and hydrogen sulfide gas, the method comprises adding an oxidizing agent selected from the group consisting of O₂, N₂O, a mixture of air with 0.1 to 5 vol % sulfur dioxide, a mixture of oxygen with 0.1 to 5 vol % sulfur dioxide, and combinations thereof.

10. The method according to claim 1, further comprising adding air after the contacting step.

11. The method according to claim 1, wherein the acidic aqueous solution has a concentration of acid ranging from 18 mol/L to 0.0001 mol/L.

12. The method according to claim 1, wherein sulfur dioxide is fed during the contacting step as a gas at a rate of 1 to 500 Nl/kg of the material.

13. The method according to claim 1, wherein, subsequent to the contacting step, the method further comprises adding an additional material comprising one or more selected from the group consisting of metal oxides, metal hydroxides, metal carbonates, metal bicarbonate, and combinations thereof.

14. A method for recycling at least one battery material selected from the group consisting of a lithium ion battery, lithium ion battery waste, lithium ion battery production scrap, lithium ion cell production scrap, lithium ion cathode active material, and combinations thereof, wherein the method comprises:
optionally, heat treating the at least one battery material at a temperature ranging from 350° C. to 900° C.,
mechanically comminuting the at least one battery material to obtain a comminuted material,
optionally, sorting the comminuted material to obtain a fine fraction and a course fraction, and
subjecting the comminuted material, optionally the fine fraction, the course fraction, or the fine fraction and the course fraction, to the method according to claim 1.

15. The method according to claim 1, further comprising smelting the composition comprising copper sulfide.

16. The method according to claim 1, further comprising roasting the composition comprising copper sulfide.

17. A composition comprising copper sulfide prepared according to claim 1.

18. The method according to claim 2, wherein the solid-liquid separation is selected from the group consisting of filtration, sedimentation, centrifugation, and combinations thereof.

19. The method according to claim 3, wherein the solid-solid separation is selected from the group consisting of flotation, magnetic separation, gravity separation, dense media separation, and combinations thereof.

20. The method according to claim 1, wherein one or more metals in a zero oxidation state selected from the group consisting of Ni, Co, Mn, Fe, and combinations thereof, is added to the material prior to and/or during the contacting step.

21. The method according to claim 9, wherein no oxidizing agent is added until after the hydrogen gas formation.

22. The method according to claim 10, wherein no air is added until at least 1 minute, at least 10 minutes, at least 30 minutes, at least 1 hour, or at least 2 hours, after the beginning of the contacting step.

23. The method according to claim 1, wherein the acidic aqueous solution is not sparged with an oxidizing agent (e.g., air) prior to the contacting step.

24. The method according to claim 1, wherein no oxidizing agent other than sulfuric acid is added to the acidic aqueous solution prior to the contacting step.

25. The method according to claim 1, wherein, at the beginning of the contacting step, less than 50 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode.

26. The method according to claim 1, wherein, at the beginning of the contacting step, less than 25 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode.

27. The method according to claim 1, wherein, at the beginning of the contacting step, less than 10 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode.

28. The method according to claim 1, wherein, at the beginning of the contacting step, less than 1 mol % of oxidizing agent, other than sulfuric acid, is present in the acidic aqueous solution by total moles of the copper in a zero oxidation state and the zero oxidation state metals having a standard redox-potential less than zero volt versus a standard hydrogen electrode.

29. The method according to claim 10, wherein the subsequent addition of air begins at least 1 minute after the contacting step begins, at least 10 minutes after the contacting step begins, at least 30 minutes after the contacting step begins, or at least 1 hour after the contacting step begins.

30. The method according to claim 10, wherein the subsequent addition of air begins from 0 minutes to 2 hours after the contacting step begins.

31. The method according to claim 1, wherein the composition comprising copper sulfide is separated by flotation in the presence of a xanthate, a dithiophosphate, a thionocarbamate xanthogen formate, a xanthic ester, and/or a mercaptobenzothiazol collector.

32. A method comprising leaching a material according to the method of claim 1 to obtain an aqueous solution comprising metal ions and separating the metal ions to obtain at least one essentially pure metal ion solution and/or at least one essentially pure solid metal ion salt.

33. The method according to claim 1, wherein contacting the material with the acidic aqueous solution having a pH less than 6 causes a formation of hydrogen gas, and the acidic aqueous solution having a pH less than 6 is contacted with the sulfur dioxide during the formation of hydrogen gas.
